(19) United States
(12) Patent Application Publication
(10) Pub. No.: US 2026/0359865 A1
(43) Pub. Date: Nov. 12, 2026

(54) Mobile Billboard

(71) Applicant: Lime Media Group, Inc., Rockwall, TX (US)

(72) Inventor: Andrew Moehlman, Rockwall, TX (US)

(21) Appl. No.: 19/348,858

(22) Filed: Oct. 3, 2025

Related U.S. Application Data
(60) Provisional application No. 63/802,725, filed on May 9, 2025.
(60) Provisional application No. 63/880,026, filed on Sep. 11, 2025.

(51) Int. Cl. G06Q 30/0251; G06Q 30/0242

(52) U.S. Cl. CPC G06Q 30/0266; G06Q 30/0244

(57) ABSTRACT

A mobile billboard system and method is disclosed herein. The system tracks and compiles data relating to an output. The system variables, including location, type of advertisement, duration, frequency, proximity to an advertiser, etc., can be varied to optimize a given output. The output can include foot traffic, sales, etc. Logging the data allows advertisers to see a direct correlation to the advertisement and the output.

### PRIORITY

The present invention claims priority to U.S. Provisional Application No. 63/880,026 filed Sep. 11, 2025 as well as U.S. Provisional Application No. 63/802,725 filed May 9, 2025, the entirety of both of which are hereby incorporated by reference.

### BACKGROUND OF THE INVENTION

### Technical Field

The present invention relates to a system and method for a marketing mobile billboard.

### Description of Related Art

Advertisements are used to provide information to a potential customer to allow them to learn about someone's goods or services. Advertisements have been long known to be beneficial to businesses. Mobile advertisements are also useful as they allow potential customers to be aware of goods or services which are in close proximity to the advertisement.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a mobile billboard in one embodiment;

FIG. 2 is a perspective of a display billboard in one embodiment;

FIG. 3 is a schematic of a mobile billboard system in one embodiment;

FIG. 4 is a schematic of a system with multiple vehicles in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

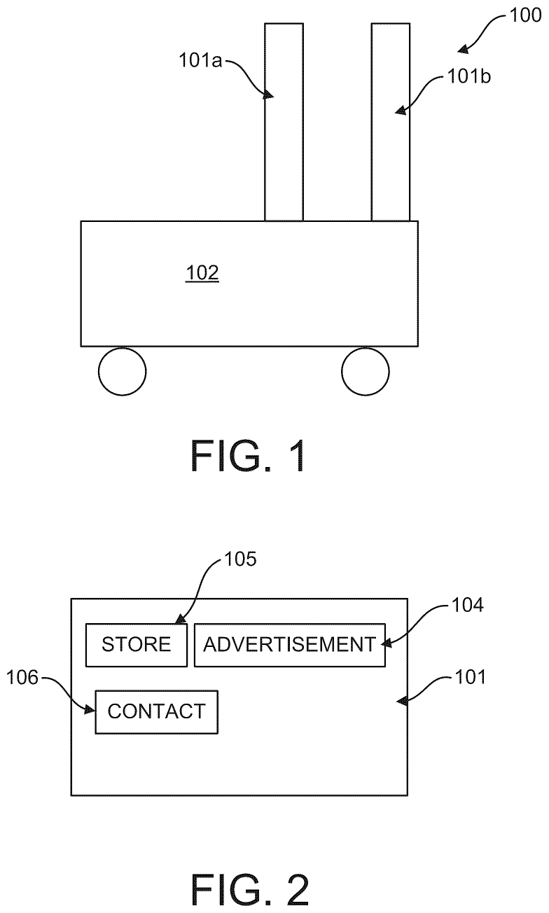

FIG. 1 is a perspective view of a mobile billboard system 100 in one embodiment. As shown the system 100 comprises a vehicle 102 coupled to two billboards 101a,b.

The vehicle 102 can comprise virtually any vehicle 102 known in the art. This can include trucks, vans, cars, electric cars, buses, trains, etc. Any mobile object which is capable of moving and displaying the billboard 101 can be used.

The billboard 101 can be coupled in any fashion so that it can display information to potential consumers. In one embodiment the billboard 101 is coupled to a truck, for instance, and as the truck moves around, additional potential customers are able to see the billboard 101. As noted, the use of a truck is for illustrative purposes only and should not be deemed limiting. As shown, the system shows two billboards 101a,b. One (101a) is facing forward and the other (101b) is rear facing. In other embodiments the system 100 can utilize a single billboard 101, whereas in other embodiments two or more are utilized. In one embodiment, the system 100 utilizes three or more separate billboards 101. The billboards 101 can face the same or different directions. The billboards 101 can display the same advertising or different advertising.

Turning now to FIG. 2, FIG. 2 is a perspective of a display billboard in one embodiment. The billboard 101 can display virtually any type of relevant information. The billboard 101 can display advertisements, store locations, contact information, etc. As shown, the billboard 101 is shown displaying an advertisement 104, contact information 106, and the name of the advertiser/store 105. While the term “store” is used herein, this is for illustrative purposes only and should not be deemed limiting. The advertiser can comprise any retailer, store, provider of goods or services, etc. Virtually any business which offers a product or service can be an advertiser on the mobile billboard 101.

The contact information 106 can include any information that enables a potential consumer to reach the advertiser. This can include a physical address, an email address, a phone number, social media handles, a QR code, etc. This allows a potential consumer to contact and reach the advertiser.

The advertisement 104 can include information about a specific product or service. It can include static images or video images. The advertisement 104 can include a QR code, or equivalent link, which allows the potential consumer to learn more about the product or service.

As noted, advertising is well known. However, targeting advertising has many advantages over generic advertising. Targeting advertising targets a specific consumer base. As an example, consumers can be targeted by their location. The mobile billboard system 100 discussed herein offers an opportunity to better target potential consumers by their location, as will be discussed in more detail below.

As will be discussed in more detail below, the specific advertisement displayed can change based on a variety of factors. In one embodiment the entire advertisement changes. In other embodiments, however, portions of the advertisement changes. For example, the specific store 105 can change with all other portions of the advertisement remaining the same. In other embodiments, the contact 106 information changes, with the remaining of the advertisement remaining the same. This allows small tweaks to the advertisement to be made. These small tweaks can be optimized to achieve the most optimum advertisement. Thus, while one embodiment discusses changing the advertisement, it should be noted that portions of the larger advertisement can be changed.

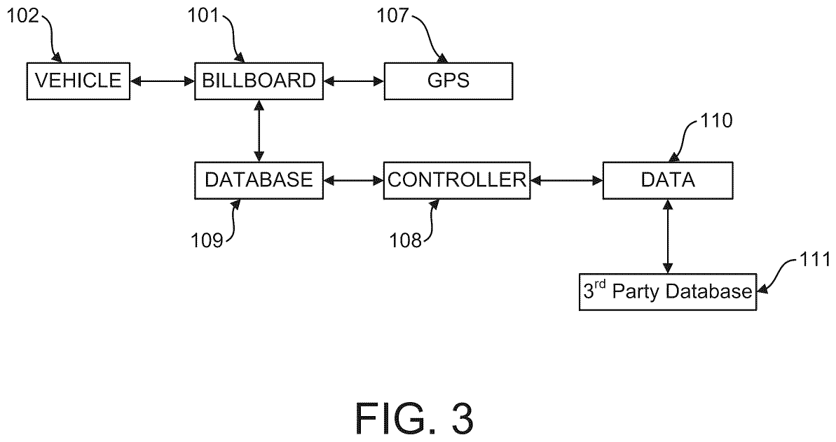

Turning now to FIG. 3, FIG. 3 is a schematic of a mobile billboard system 100 in one embodiment. FIG. 3 shows several various components in communication with one another. The communication can be wired, or it can be wireless. Virtually any network architecture and the corresponding security can be utilized. This can include 5G technology, TLS-encryption, etc. In one embodiment the system can utilize edge caching to allow sub-second swaps. This can be used, for example, when latency is high.

It should be noted that while the billboard 101 is shown in communication with the database 109, this is for illustrative purposes only and should not be deemed limiting. The billboard 101, for example, can also be in communication with the controller 108. In other embodiments, the billboard 101 is not in communication with the database 109 but is only in communication with the controller 108. The point is that this schematic is to illustrate the functionality and resulting advantages and is not meant to limit the specific arrangement and connectivity between components.

While a single database 109 is shown, this is for illustrative purposes and should not be deemed limiting. There can be a database 109 for storing potential advertisements. There can be a database 109 for storing collecting data, such as location data. These can comprise the same or different databases. Further, these databases can be stored locally or remotely.

The vehicle 102 was discussed previously. The route and direction of the vehicle 102 can be random, or it can be provided and directed by the controller 108. In some embodiments the vehicle 102 has a specific and set route. In certain embodiments, for example, the vehicle's 102 entire purpose is to advertise and promote the billboard 101. In such embodiments, the vehicle's 102 route can be optimized to reach and direct as many potential consumers as possible. In other embodiments, however, the vehicle 102 is simply a vehicle used for everyday purposes. The vehicle 102, for example, may be a ride share car which has no set route. In such embodiments, the route is not set but rather the display of the billboard 101 can vary depending upon the route selected by the vehicle 102.

As noted, the billboard 101 is coupled to the vehicle 102. In one embodiment the billboard 101 comprises an LED billboard. The billboard 101 can display static images, video, etc. In some embodiments the billboards 101 are configured to emit sounds, whereas in other embodiments, the billboards are solely visual.

The billboard 101 can comprise virtually any screen or display which can display an advertisement. This can include an LED as described, a monitor, a television, etc. The billboard can be planar, curved, etc. Further, the billboard 101 can face a single or multiple directions.

The billboard 101 is coupled, either directly or indirectly, to a GPS system 107. This enables the vehicle 102 and/or the billboard 101 to ascertain where the billboard 101 is currently located. This information can be provided to the controller 108 which can use the location information to provide targeted advertisements based on the current or projected location. As will be described, in one embodiment the system uses and stores a plurality of possible advertisements. The system selects one specific advertisement to display. Data associated with the display of that specific advertisement is collected and tracked. Thereafter, different advertisements can be displayed and the associated data collected. The collected data can be attributed to the specific advertisement displayed.

As an example, if the system did not know the location of the billboard, the billboard could display generic advertising information. The billboard could advertise for company XYZ. However, if the system knows the location of the billboard 101, the billboard 101 can display targeted advertising which is relevant to that specific location. If the billboard 101 is located in the North part of town, the billboard 101 can display advertisement and business information which is relevant and tied to the North part of town. This allows the billboard 101 to provide targeted information which is targeted to potential consumers who are geographically proximate to the advertised location. Targeted advertising is often more successful than generic information.

The controller 108 can utilize the current location of the billboard 101 to determine which advertisement to utilize. However, the controller 108, when the billboard's 101 route or future location is known, can also utilize that information in selecting which advertisements to display.

In one embodiment the content of the billboards 101 changes dynamically when the vehicle 102 is moving and as its location is determined by the GPS 107. The location can then be crossed with a database of addresses for potential advertisers. In some embodiments, proximity to the store is a significant factor in determining which advertiser to show. While the vehicle 102 is generally moving, stationary vehicles 102 can also be used.

In one embodiment, the controller 108, or other components of the system, utilize geofencing to draw a unique boundary around the billboard 101. The geofence can comprise virtually any distance or boundary. As but one non-limiting example, the system 100 can apply a geofence of 1 mile. This means that the controller 108 will limit displayed advertisements to locations which are within 1 mile of the billboard 101. The size, shape, and radius of the geofence will depend upon the advertisers, the location, etc. As an example, in a walkable city, the geofence might be reduced to a few city blocks to ensure potential consumers can walk to the advertised store. This is but one example of the targeted and unique advertisement which can be presented when the system 100 knows the location of the billboard 101.

In other embodiments, a traditional geofence is not utilized. Instead, the location of the billboard 101, as determined by the GPS 107, is then used as a factor in determining which advertiser to display. Thus, proximity from the billboard 101 to the store is a factor in ranking which advertiser to display.

The controller 108 can use a variety of factors in determining which displays to show on the billboard 101. As noted, location or future location is one factor. Other factors, such as store hours, or weather, traffic densities, etc. can also be utilized. As an example, if there are two potential stores which meet the location requirements, but Store A is currently closed, then the system can opt to display Store B, which is open. Additionally, the local time is also a consideration which can be a factor for the controller 108. If Store A is for a commercial product, but Store B is for a restaurant, and the local time is around lunch, the system can opt to show advertisements for Store B which may result in more successful targeting advertisement due to the proximity of lunch time.

As to weather, the controller 108 can determine which potential store to advertise based on the weather. As an example, if a potential advertiser is a car wash, and the weather is rainy, the controller 108 can select a different advertiser. In one embodiment, the route can shift from parks/outdoor events to covered shopping centers. The advertisement can focus on indoor content, warm color hues, and hot drinks/dishes, as but one example. For hot days, the route, for example, can favor shaded downtown streets and pedestrian zones with slower speeds. The system can opt to skip outdoor areas in the warmest parts of the day. The advertisement can include indoor content, cool color hues, drinks/ice cream, indoor attractions, etc. On a clear day or weekend, the route can include loops around parks, waterfronts, event areas, etc. The content can include outdoor content, apparel/sunscreen/sports themes, as well as event promotions. Thus, weather and weather predictions are other factors that can be used to determine displays.

Another factor which can be used to determine which advertiser to show is traffic, traffic patterns, and projected traffic. In some embodiments, displaying on a lonely, deserted street is to be avoided. Thus, to get more potential eyes, and impressions, the system can utilize existing and predicted traffic patterns to control both the route and the display. If a potential viewer is stuck in traffic, for example, the viewer might be less inclined to pay attention to a water park advertisement. However, that same potential viewer can be more susceptible to a display regarding a radio station or podcast.

If there is congested traffic, the system can route vehicles to maximize dwell time/exposure. The advertisement can include longer messages, QR codes, multi-frame storytelling advertisements, etc. This is because of the increased dwell time.

If there is gridlock or road closers the system can reroute to parallel routes that keep schedule and coverage targets. The advertisement content can comprise virtually any advertisement.

In one embodiment, the system factors events such as football games, concerts etc. This allows the route to be staged outboard 30-60 minutes after the event for high impressions but low dwell time. The advertisement here can comprise shorter messages, single frame ads, etc. Thus, using the traffic information can optimize both the route and the display.

While the example above illustrates two competing stores, in other embodiments the same advertiser can have various locations. Consider Store A which can have dozens of retail locations within a given city, for example. The system 100 will decide to advertise for Store A, but the system 100 will then have to determine for which location to advertise. As the vehicle 102 moves through the city, the specific location for Store A will dynamically change based on the closest, by proximity, store location.

Information relevant to the various advertisers (such as Store A or Store B) can be stored in a database 109. The database 109 can be stored close to the controller 108 or remotely stored from the controller 108.

In one embodiment, the controller 108 utilizes information from the database 109 in determining which advertisers to promote with the billboard 101.

In one embodiment, the database 109 monitors how long, when, where, etc. a specific advertiser was advertised. Thus, the system tracks how long, when, etc. a specific store, as an example, was advertised. Due to the GPS 107, the system knows where and when that specific store was advertised. This new data is logged and tracked. This is a new piece of data which offers many benefits and advantages. In one embodiment, the controller 108 utilizes this data in determining which advertiser to advertise. As an example, if Store A was recently advertised, the system can determine to advertise Store B.

In one embodiment the data comprises second-by-second geo-logs, ad logs, device IDs, etc. The system can track and report second-by-second accounts for various key performance indicators. The ability to track, in real-time the variables offers better predictive analysis as well as better data to the customer. This allows data, and the results, to be better tracked and correlated. This data allows billboard exposures to be tracked to offline conversions.

As an example, the key performance indicators can be correlated with third-party output metrics. Output metrics are trackable terms which can be measured and tracked. Output metrics can include sales, foot traffic, redemption of coupons, inquiries, phone calls, etc. Thus, as an example, second-by-second geo-logs, ad logs, device IDs, and other key performance indicators can be associated and tracked against sales and foot traffic. This provides better predictive analysis as far as which key performance indicators to track, optimize, etc. This also provides machine learning an opportunity to create better predictive models.

Various statistical approaches can be used for the correlation. These can include, but are not limited to, difference-in-differences, propensity score matching, geo-based synthetic control, etc. Those skilled in the art will understand the applicability of various models depending upon the specific inputs and outputs monitored. In some embodiments, these models can be used simultaneously to weigh the predictive outcomes with the measured outcomes. This allows the system to determine which statistical or prediction system is more accurate.

As noted, this data has very significant advantages and benefits. First, because the frequency of advertising with an advertiser is stored and cataloged in the database 109, such information can be used to track return of investment from the advertisement. Consider an advertisement for Store A which experienced increased foot traffic for the immediate two hours after being advertised on the billboard 101. This is now data that can be used to calculate a return on investment for Store A. Store A has a quantifiable benefit from the advertisement, which is often difficult to obtain. Store A knows that foot traffic increased after local and targeted advertising with the mobile billboard 101. As such, Store A can justify advertising again, advertising more frequently, etc. Store A now has a lever of control with the mobile billboard 101 which previously did not exist.

The stored data can also help an advertiser, such as Store A, refine the advertisement. Perhaps during the hours of 9 AM-noon resulted in a 10% increase in foot traffic through the store, while, the hours of 3-6 PM resulted in a 25% increase in foot traffic. Store A now knows that the evening advertising hours are more effective than the morning advertising hours. The controller 108, and/or Store A, can now adjust the advertising hours to reflect the newly acquired data. This allows for more effective, and cost effective, targeted advertising than previously available. As will be discussed, implementing the changes based on the results can take place manually, or in some embodiments, it can occur automatically. In some embodiments the results will be reviewed on a periodic basis, and changes can subsequently be made to optimize the input factors to maximize the desired outputs, such as foot traffic, sales, etc. The operator can relay to the advertiser why changes are being made and highlight the outputs, return on investment, etc. In other embodiments, these changes are made automatically based on data received by the system.

As noted, foot traffic and other data can be stored and tracked along with impressions captured while the vehicle 102 is moving. The data can be broken down into gender, income range, age range, race, etc. Thus, the data is not limited to global foot traffic or global impressions. Rather, the data can be tracked along demographics which is helpful in targeting advertising.

FIG. 3 shows a third-party database 111. This third-party database 111 can belong to the advertiser, as an example. The third-party database 111, in one embodiment, houses and has access to different data than the operator's database 109.

The third-party database 111 can track various data which the system 100 might not otherwise be able to access. This can include sales from the advertiser. This can also include foot traffic data. Other data which can be tracked can include sales inquiries, search engine queries, social media impressions, etc. Virtually any data which a business tracks can be included and provided from the third-party database 111. Such data, as explained below, can be used to determine if there are any correlations or impacts on the data from the mobile advertisements.

As but one example, consider Store A, which has a third-party database 111 which tracks foot traffic and real-time sales. In one embodiment, data from the third-party database 111 is partially shared with the system 100. The system can be provided access to the third-party database 111, even if limited. In other embodiments, data is provided directly to the operator who can input the data to the operator's database 109. Thus, while a separate database is shown, this is for illustrative purposes only. The data is what is important, and the data can be obtained and/or accessed via multiple different mechanisms.

The system 100 can utilize the data from the third-party database 111 to correlate objective and measurable success, as in foot traffic and/or sales, to 1) location of the advertisement, 2) duration of the advertisement, 3) frequency of the advertisement, 4) time and date of the advertisement, etc. Correlating this data allows the system to maximize the potential quantifiable results to increase the impact of the advertisement.

Because the GPS information is available, even the direction the billboard 101 is facing can be tracked and optimized. If the billboard 101 only has one side, for example, and the vehicle 102 is travelling North, then potential consumers facing South will see the billboard 101. Having access to the advertiser's data allows the system to track, optimize, and, if necessary, adjust even the direction the billboard 101 is facing.

As noted, frequency of the advertisement can be correlated and maximized against other data to maximize future advertisements. However, the location can also be maximized. The system can track the location of the billboard 101. Given the availability of data, the system can correlate different geofences to determine which geofence is more efficient. As an example, consider if sales spike when the billboard 101 is within 2 miles but there is no noticeable change in sales if the billboard is greater than 2 miles. The geofence parameters can then be adjusted to maximize the impact of the advertisement.

An additional factor which can be optimized is the type of advertisement. Often it is difficult to ascertain which specific advertisement was effective. Consider a first advertisement which has a QR code, or other link, which provides the potential consumer with an opportunity to obtain more information. Consider a second advertisement which has no QR code but instead provides a brief video. If the dates, locations, etc. are held constant, and the second advertisement achieves greater foot traffic or sales, the system recognizes to prioritize the second advertisement over the first advertisement. Thus, even the content of the advertisement can be adjusted and optimized for a given advertiser. Accordingly, in one embodiment the entire advertisement can dynamically change.

As noted, the system allows for modifying the advertisement, and the advertising content, and recording the impact, if any. The system provides for dynamically changing the advertisement based on geography and other factors. As an example, Advertisement A might work better than Advertisement B in varying neighborhoods. The system can change between advertisements and measure the impact of that change.

FIG. 3 shows the data 110 that is obtained from and/or provided to the controller 108. As shown, in one embodiment, the data 110 can include data from a third-party database 111. The data 110, in one embodiment, takes the form of a report. The data 110 can be provided to the advertiser. The data 110 can include virtually any type of data which is helpful to the advertiser. The data 110 can include information which illustrates a return on investment from the advertisement. As an example, the data 110 can be a report which correlates foot traffic, sales, etc. directly to the advertisement through the mobile billboard 101. As noted, in one embodiment the report can include logs for each address, duration, timestamp, etc. These reports can be configurable reports which can include templates for various advertisers. The reports can be custom made to fit the desirable variables important to a specific advertiser. As noted, advertisers can use this data to correlate exposure with foot traffic and/or sales metrics, impressions, etc. In some embodiments the advertisers have direct access to the data and can assist in configuring the report into actionable insights. In some embodiments, advertisers can select and modify their own reports. In one such embodiment, advertisers can select which variables are pertinent to their industry and business.

The data 110 can show the impact of the mobile billboard 101 through time. Thus, the data 110 can show that the system increased the quantifiable results by optimizing time, location, content, etc. Thus, the data 110 can show that the positive benefits of advertising, such as foot traffic, sales, inquiries to the store, search engine queries, etc., can be optimized across the wide variety of factors discussed herein.

In one embodiment, the data 110 includes data relating to the relative distance from the store and the mobile billboard 101. The data 110 can include, as an example, average distance from the store and the mobile billboard 101. The actual distance can then be measured against outputs such as foot traffic, sales, etc.

In one embodiment, the data 110 includes data relating to how much time the advertisement was displayed rather than basing it on the schedule alone. As noted, in some embodiments, the system 101, either on its own or based on instruction from a user, will switch advertisements. Even if one advertisement is scheduled to appear, the system, in some embodiments, can override the schedule in an attempt to optimize the desired outputs. As such, in one embodiment the data 110 relates specifically how much the advertisement was displayed as opposed to how long it was planned to be displayed.

In one embodiment the system 100 utilizes device sniffers. A device sniffer is a device which can sniff or monitor impressions. As but one example, a device sniffer can include a Bluetooth or WiFi sniffer which counts impressions from other devices, such as phones, tablets, etc. A device sniffer provides an additional metric which can be used to count impressions. The impressions can be included in the data 110 to relay to the user. Further, the device sniffer can also be used in the optimization in determining routes, which routes were successful, etc. There are variety of device sniffers which can be used. It can include a passive RF scanner, as an example. The results can be delivered to the controller 108, the database 109, or the third-party database 111.

As noted, the system can utilize data from sniffers in optimizing content delivery. While the sniffers may provide aggregated or anonymized metrics, the system uses adaptive content-selection, via various methods and engines, to consume and use these metrics. Furthermore, even aggregated metrics can be tied to other variables such as location, direction, time of day, weather, etc. to correlate the data from the sniffers.

In one embodiment, the system can comprise a beacon to count nearby phones over Wi-Fi or Bluetooth. The system can report how many devices are nearby, so that the impressions can be counted. In one embodiment, mobile-app location data can be aggregated so that the number of devices in one place at a given time can be tracked.

In one embodiment the system uses camera-based counts. A camera-based count can estimate the number of people within a given frame.

While one embodiment has been described utilizing a schedule, in one embodiment, as noted, the system is fully automated based on proximity. The billboard 101 can change dynamically in real-time based on its location. In one embodiment the location is pinged every 2 minutes, and the new location is then used to determine the preferred advertisement. The location can be pinged more or less frequently. In one embodiment, the location is pinged every few seconds to allow the system to quickly change if necessary. In one embodiment, the GPS is accurately tracked such that the location of the billboard 101 is tracked with sub-mile precision, to ensure that the preferred advertisement is properly displayed.

In one embodiment the data 110 uses time-verified logs to verify the advertisements were displayed as suggested. In some embodiments, and in some industries, there are regulations requiring proof that certain statements or advertisements are made. A time-verified log can serve as this proof. This is a benefit as currently there is no mode of collecting this data automatically.

In one embodiment, the data 110 can include demographic overlay integration. This can be accomplished in a variety of methods, including third-party data sources. This, and other data, can enhance route and message optimization.

In one embodiment, the controller 108 utilizes a series of rules-based prioritization in determining what advertisement to display. As an example, if the lunch hour is optimized to showcase Store A, but Store B has not been displayed recently, the system 101 can use rules to prioritize which advertisement should be shown. In one embodiment these changes are accomplished manually by a human operator. In other embodiments, the system utilizes a combination of human and automatic changes. As an example, in some embodiments an operator will manually schedule the advertisements for a given mobile billboard 101. However, as data is acquired, and the various input factors are optimized and adjusted, the system can automatically make adjustments in selecting advertisements which are different than those scheduled. The system, in some embodiments, can make changes in real-time.

In one embodiment the system 100 utilizes machine learning or artificial intelligence to optimize the route, the display, and other inputs. The system can utilize the same data previously discussed. This can include GPS, time-of-day, audience metrics, weather, etc. Various models can be used. In one embodiment the system utilizes supervised machine learning. This is a model whereby an algorithm learns from a given dataset. The dataset can include inputs such as weather, location, etc. and can optimize outputs such as impressions or foot traffic. In one embodiment the model is a gradient-boosted trees model. In one embodiment, the system predicts the expected benefit from various pairings.

In other embodiments the system utilizes reinforcement-learning or bandit approach which can explore new approaches when the confidence is low.

As but one example, in one embodiment, the system includes a data ingestion step, followed by model training, then an inference step, a content decision step, and then key performance indicators (KPIs) feedback.

In one embodiment the raw logs can be stored in any object store, including an S3-type object store. The system, as noted, can create a semantic layer which serves as a business-friendly interface which converts complex data into business terms. Virtually any framework to house data can be utilized, including but not limited to, Apache Spark, and Apache Flink. In one embodiment the database comprises a distributed data lake and the controller 108 executes a machine-learning model trained on historical data.

In one embodiment the controller 108 can relay feature-attribution scores. These are reference points which allow the operators to monitor and optimize. The operator can opt to pin or black-list some variables. Thus, the operator can disable or enable certain variables and allow the system to focus on the remaining variables. Conversely, the operator can highlight a variable and give it a larger priority.

In one embodiment the system can optimize the route of the billboard 101. A given route might initially seem preferable. However, when additional data is obtained, the route can be optimized as necessary. As an example, if Store A benefits more in the morning hours, but Store B benefits more in the evening hours, the route can be adjusted as necessary to ensure both Store A and Store B are optimized. As noted, even the direction of the route can be optimized based on the results.

While an illustrative embodiment has been discussed with a single vehicle, this is for illustrative purposes only and should not be deemed limiting. In other embodiments, a fleet of vehicles can be controlled as discussed herein. The number of vehicles is yet another variable which can be optimized.

Increasing the number of vehicles also increases the impact and speed of machine learning because more data will be acquired at a faster pace. Further, the system can use a fleet of vehicles to test various inputs to measure their impact. A vehicle can travel North while the same vehicle travels South on the same street to monitor the impact and impressions received. Further, the space and time between successive vehicles can be altered. Perhaps it makes sense to have a first vehicle get the viewer's attention, and then subsequently, a second vehicle provides additional time for the viewer to write information.

Additional vehicles also increase the billboards which are available. A customer can set a specified budget. That budget can be optimized through a variety of inputs, including number of vehicles, to optimize impressions per dollar spent.

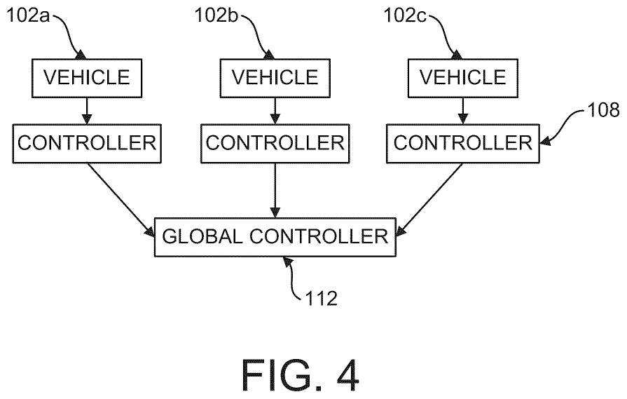

FIG. 4 is a schematic showing a plurality of vehicles 102a, 102b, 102c. Each vehicle can comprise one or more billboards 101. As noted, each vehicle is in communication with a controller 108. In the embodiment depicted there is a global controller 112 which sends commands to each individual controller 108. In this fashion, a global controller 112 makes the decisions and sends these decisions to each separate vehicle via their controller 108. A global controller 112 allows a central decision maker to plot and execute the strategy. This allows data from each vehicle 102 and controller 108 to be utilized for prediction and optimization. In other embodiments each vehicle operates independently. The global controller 112 can be stored locally or remotely.

As noted, it is often previously difficult for a store, or business, to quantify the impact of advertising. The impact of advertising refers to any quantifiable metric which can be, in part, attributed to the advertising. The impact can be the metrics described herein, impressions, foot traffic, sales, inquiries, contacts, coupons used, etc. However, a mobile billboard 101, with the data tracked here, offers a unique ability to measure the benefits from the advertisement against the factors behind the advertisement. A store owner can see and track the benefits of advertisement to justify future advertisements. Further, because the advertisements can be optimized, an advertiser can, in certain embodiments, obtain more benefit from reduced advertisements, if those reduced advertisements are placed at optimized locations, time, etc.

A mobile billboard system has been described. In one embodiment a method of optimizing advertising impact is disclosed. The method can be used on the system described herein. As noted, often it is difficult to quantify advertisement impact. However, by utilizing the system and method herein, the advertisement impact can be tracked and optimized. Users will recognize the impact of the advertisement in terms of dollars spent, impressions, foot traffic, etc. Users can utilize the reports discussed herein to budget and plan for future advertisement spends. Further, the users can determine how to prioritize their advertisement budget based on the results found in the report.

In one embodiment, the method begins by selecting one advertisement from a plurality of possible advertisements to display on a mobile billboard. The initial selection can be selected by the operator, or it can be selected based on historical data. Then, the mobile billboard is moved. As noted, the location of the billboard is tracked. The sniffers, counters, etc. can be utilized as previously described. The method includes collecting location data, impression data, and at least one key performance indicator associated with said one advertisement. As previously noted, output metrics from third-party databases can be utilized. It should be noted that in one embodiment the third-party database is so-called third-party because data is collected from an outside party. It might be that Store A measures and collects data. Store A's database is considered the third-party database, even if they are the user.

The output metric is correlated against at least one key performance indicator which is associated with the one specific advertisement. As noted, in some embodiments the selected advertisement will be displayed multiple times. As such, there are multiple data feeds which can be compared.

As noted, the system can generate a report which includes output metrics associated with the advertisement. This allows the user to understand the benefit from the advertisement spend.

The system 100 discussed herein, in one embodiment, tracks 1) location, 2) geofence, if any, 3) duration of advertisement, 4) date and time of the advertisement, and 5) type of advertisement. The system can utilize a database 109, and/or a third-party database 111 to correlate the system variables to maximize a given output. The output, as noted, can be foot traffic, sales, sales contacts, sales inquiries, search engine inquiries, social media impressions, etc. By tracking a given output, the system variables can be changed as desired. By tracking the output against the system variables, significant and valuable data is created. The data 110 can be automatically generated and provided to the advertiser, or it can be created and modified by the user, and subsequently provided to the advertiser. The advertiser, now armed with data, can make better determinations about future advertisement projects.

While the invention has been particularly shown and described with reference to a preferred embodiment, it will be understood by those skilled in the art that various changes in form and detail may be made therein without departing from the spirit and scope of the invention.

What is claimed is:

1. A mobile billboard system comprising:
a vehicle;
a billboard coupled to said vehicle;
a global positioning system coupled to said vehicle to provide location data;
a database for logging and storing data, wherein said system comprises a database which stores a plurality of possible advertisements;
a controller which utilizes said data to select one of said plurality of possible advertisements to display on said billboard;
wherein said controller uses said location data in selecting one of said advertisements.

2. The system of claim 1 wherein said advertisement changes dynamically based on said location data.

3. The system of claim 1 wherein said controller utilizes proximity data in selecting an advertisement.

4. The system of claim 1 wherein said controller utilizes weather data in selecting an advertisement.

5. The system of claim 1 wherein said database stores the duration and time a specific advertisement was displayed.

6. The system of claim 1 further comprising a third-party database.

7. The system of claim 6 wherein said third-party database tracks output metrics.

8. The system of claim 6 which tracks key performance indicators against said output correlatives.

9. The system of claim 1 further comprising a plurality of vehicles, wherein each vehicle is coupled to a local controller.

10. The system of claim 1 further comprising a global controller which sends instructions to each local controller.

11. The system of claim 1 wherein said vehicle comprises two or more billboards.

12. The system of claim 1 wherein said vehicle comprises a device sniffer.

13. The system of claim 1 further comprising a configurable report which correlates output metrics with advertising spend.

14. A method of optimizing advertising impact, said method comprising the steps of:
a. selecting one advertisement from a plurality of possible advertisements to display on a mobile billboard;
b. moving said mobile billboard;
c. collecting location data, impression data, and at least one key performance indicator associated with said one advertisement;
d. collecting output metrics from a third-party database;
e. correlating said output metric to said at least one key performance indicator associated with said one advertisement;
f. generating a report which includes output metrics associated with said one advertisement.

15. The method of claim 14 wherein at least one key performance indicator is optimized.

16. The method of claim 14 wherein said collecting of step c) comprises uses sniffers to count impressions.

17. The method of claim 14 wherein mobile billboard comprises a vehicle; a global positioning system coupled to said vehicle to provide location data;
a database for logging and storing data, and wherein said database stores the plurality of possible advertisements;
a controller which utilizes said data to control said billboard to select one of said plurality of possible advertisements to display on said billboard;
wherein said controller uses said location data in selecting one of said advertisements.
